(19) United States
(12) Patent Application Publication
(10) Pub. No.: US 2013/0054987 A1
(43) Pub. Date: Feb. 28, 2013

(54) SYSTEM AND METHOD FOR FORCING DATA CENTER POWER CONSUMPTION TO SPECIFIC LEVELS BY DYNAMICALLY ADJUSTING EQUIPMENT UTILIZATION

(71) Applicants: Clemens Pfeiffer, Sunnyvale, CA (US); Peter Maltbaek, Mountain View, CA (US); Emre Kulali, Menlo Park, CA (US)

(72) Inventors: Clemens Pfeiffer, Sunnyvale, CA (US); Peter Maltbaek, Mountain View, CA (US); Emre Kulali, Menlo Park, CA (US)

(21) Appl. No.: 13/594,752

(22) Filed: Aug. 24, 2012

Related U.S. Application Data
(60) Provisional application No. 61/528,745, filed on Aug. 29, 2011.

(51) Int. Cl. G06F 1/26

(52) U.S. Cl. 713/300

(57) ABSTRACT

A system and method for forcing data center power consumption to specific levels by dynamically adjusting equipment utilization are provided.

### PRIORITY CLAIMS/RELATED APPLICATIONS

This application claims the benefit, under 35 USC 119(e) and 120, to U.S. Patent Application Ser. No. 61/528,745, filed on Aug. 29, 2011 and entitled “System and Method for Forcing Data Center Power Consumption to Specific Levels by Dynamically Adjusting Equipment Utilization”, the entirety of which is incorporated herein by reference.

### FIELD

The disclosure relates generally to a system and method for adjusting data center power consumption based on dynamic adjustment of equipment utilization.

### BACKGROUND

Utilities are able to predict to a reasonable accuracy, generally within +/−3%, the power demand pattern throughout any particular day. This allows the electricity market to predict the power generation requirement in advance. Any imbalance would be due either to inaccuracies in the forecast, or unscheduled changes in supply (such as a power station fault) and/or demand (users needs more power on a particular day). Major imbalances of the type described are handled by the utility maintaining a reserve of power generation capacity, available to come on-line quickly, usually within 5 to 30 minutes. However, there is always a small imbalance between the forecast load and current supply as loads are switched on and off. This imbalance is generally absorbed by generators on the system running very slightly faster or slower, which causes a change in the system “frequency”. A steady frequency is essential to the stability and quality of the power supply, and thus utilities attempt to manage the imbalance. This is done by utilizing generators that are able to operate in so called frequency response mode (also called frequency control mode, or automatic generation control (AGC) mode), altering their output continuously to help keep the frequency near the required value (a “grid frequency”), which is 60 Hz in US, and may vary in other countries.

The grid frequency is a system-wide indicator of overall power balance in the utility grid. The grid frequency will drop if there is too much power demand because the power generators will start to slow down, and conversely, the frequency will rise if there is too little demand (or too much generation) at any instant in time. Generators under AGC are utilized to mitigate this problem by adding or removing power to or from the utility grid under a direct control signal from the grid operator, typically being given a new “set point” (output level) every four seconds or so. In many systems, unless there is a significant amount of hydroelectric power, there are a limited number of generating facilities that can operate under AGC, and so therefore utilities will pay well for this service. This issue is becoming more significant as the amount of renewable power on the grid increases, as renewable generation tends to fluctuate in output much more rapidly than previous sources such as fossil fuel.

Another way to manage this grid frequency problem would be through local load control where commercial and industrial rate payers would be requested to either shed or add load in order to quickly maintain the supply/demand balance on the grid. Data centers, with the capability to quickly increase or decrease power demand by managing IT and cooling load, are very well suited for regulating the frequency on the utility grid and thus participating in the ancillary services market where this type of capability is purchased. Thus, it is desirable to provide a system and method for forcing data center power consumption to specific levels by dynamically adjusting equipment utilization and it is to this end that the disclosure is directed.

### BRIEF DESCRIPTION OF THE DRAWINGS

FIG. 1 illustrates an example of a data center system that incorporates a system for forcing data center power consumption to specific levels by dynamically adjusting equipment utilization—in this case cooling;

FIG. 2 is a flowchart of a method for forcing data center power consumption to specific levels by dynamically adjusting equipment utilization;

FIG. 3 is a chart that illustrates typical load curves for a utility;

FIG. 4 is a chart that illustrates dynamic load adjustment by forcing data center power consumption to specific levels; and

FIG. 5 illustrates an example of a data center system that incorporates a system for forcing data center power consumption to specific levels by dynamically adjusting equipment utilization—in this case the IT equipment

### DETAILED DESCRIPTION OF ONE OR MORE EMBODIMENTS

The disclosure is particularly applicable to a data center system in which the data center power consumption is forced to specific levels by dynamically adjusting equipment utilization and it is in this context that the disclosure will be described. It will be appreciated, however, that the system and method has greater utility.

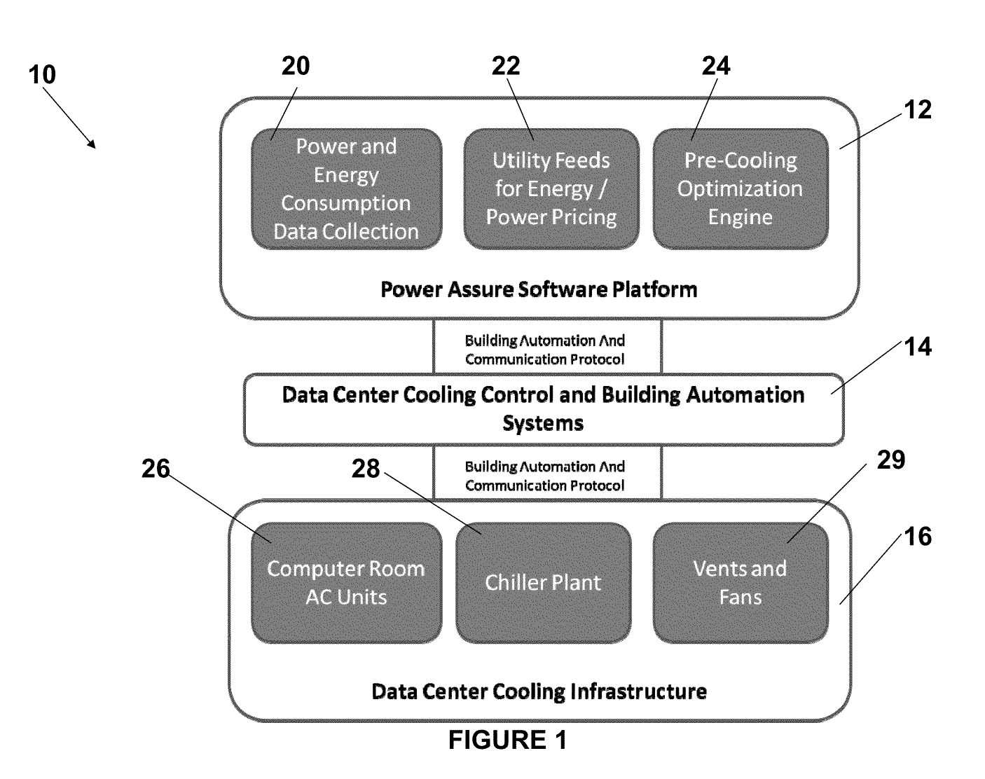

FIG. 1 illustrates an example of a data center system 10 that incorporates a data center energy storage system 12. The data center system 10 has the data center energy storage system 12, a data center cooling control and building automation system 14 that controls the data center operations including the cooling of the data center and a set of data center cooling infrastructure 16 for cooling the data center based on the control by the data center cooling control and building automation system 14. The data center energy storage system 12 communicates with the data center cooling control and building automation system 14 using various one or more known building automation and communications protocol(s) and the data center cooling control and building automation system 14 communicates with the set of data center cooling infrastructure 16 using the building automation and communications protocol.

In one implementation as shown in FIG. 1, the data center energy storage system 12 may be one or more cooling components of a data center. The data center energy storage system 12 may also be implemented in hardware. The data center energy storage system 12 may have a power and energy consumption data collection unit/module 20 (a software module in the software implementation or a hardware unit in the hardware implementation for each of these modules/units), a utility feeds for energy/power pricing module/unit 22 and a pre-cooling optimization unit/module 24. The power and energy consumption data collection unit/module 20 collects the power and energy consumption of the data center, the utility feeds for energy/power pricing module/unit 22 gather the data about the energy rates for energy at the particular data center, the utility feeds also collect consumption adjustment signals and the pre-cooling optimization unit/module 24 determines the timing for data center pre-cooling or immediate adjustments as described in more detail below. In a typical data center, the set of data center cooling infrastructure 16 may include computer room AC units 26, a chiller plant 28 and vents and fans 29 which are well known.

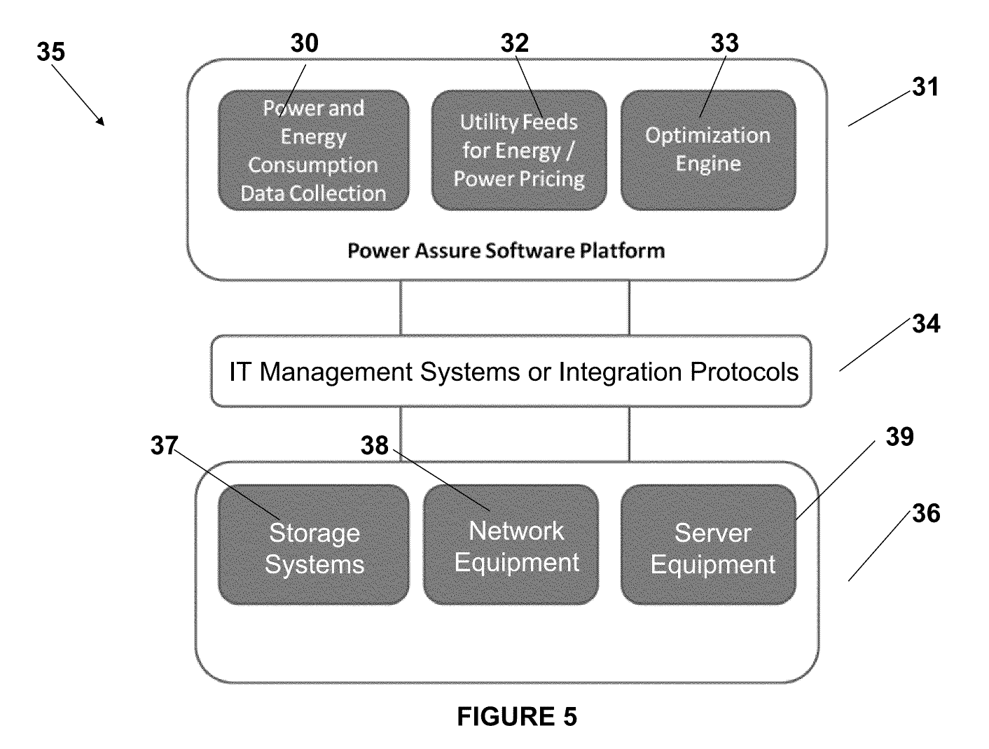

In an other implementation shown in FIG. 5, the data center energy management system 35 may be one or more server computers or other IT equipment like storage or network equipment (running in the data center for example or in a different location) that execute a plurality of lines of computer code. The data center energy management system 35 may also be implemented in hardware. The data center energy management system 35 may have a power and energy consumption data collection unit/module 30 (a software module in the software implementation or a hardware unit in the hardware implementation for each of these modules/units), a utility feeds for energy/power pricing module/unit 32 and a optimization unit/module 33. The power and energy consumption data collection unit/module 30 collects the power and energy consumption of the data center, the utility feeds for energy/power pricing module/unit 32 gather the data about the energy rates for energy at the particular data center as well as adjustment requests from the utility company and the optimization unit/module 33 determines the timing for data center adjustments as described in more detail below. In a typical data center, the set of data center equipment 36 may include storage systems 37, network equipment 38 and servers 39 which are well known.

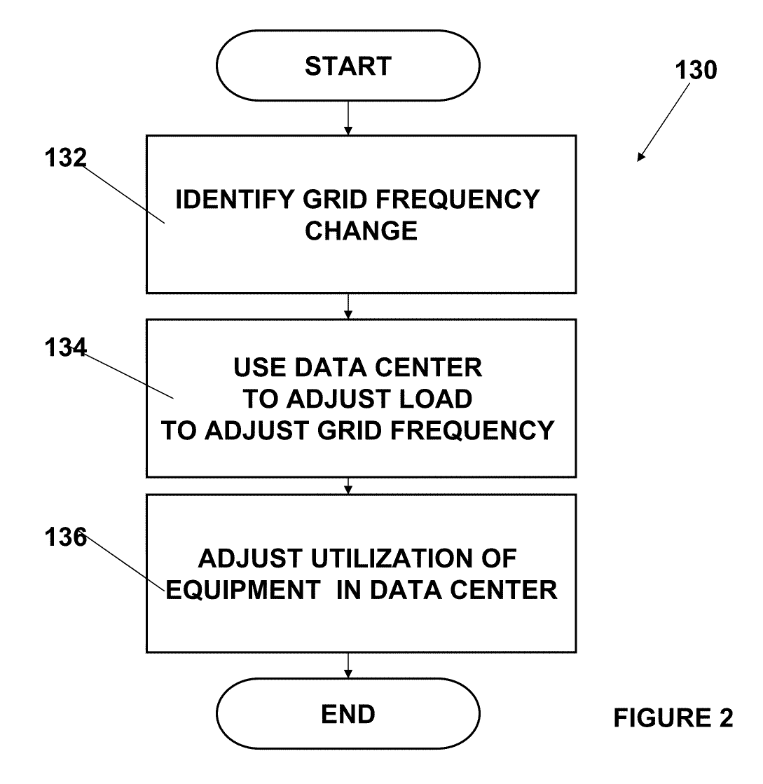

FIG. 2 is a flowchart of a method 130 for forcing data center power consumption to specific levels by dynamically adjusting equipment utilization automatically that may be implemented by the Power Assure software platform 12 shown in FIG. 1 in one implementation. In other implementations, the various processes described below may be implemented by the optimization engine. The method allows data centers to act as regulation devices for the purpose of helping to balance the electrical load on the utility grid. The method involves dynamically adjusting the data center power consumption to balance grid level variations and such adjustments can be done by increasing or decreasing cooling capacity or by dynamically adjusting the server and IT equipment utilization.

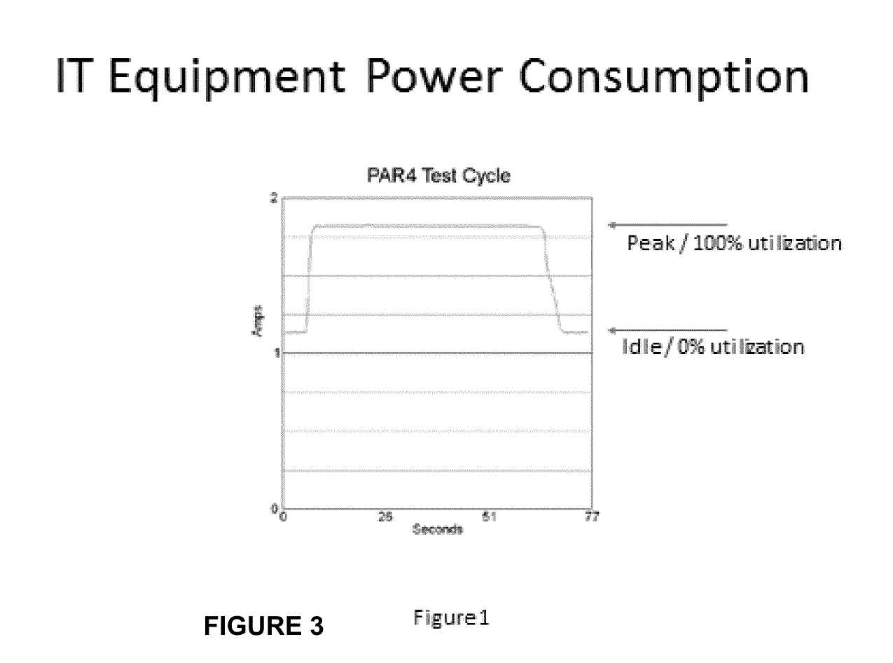

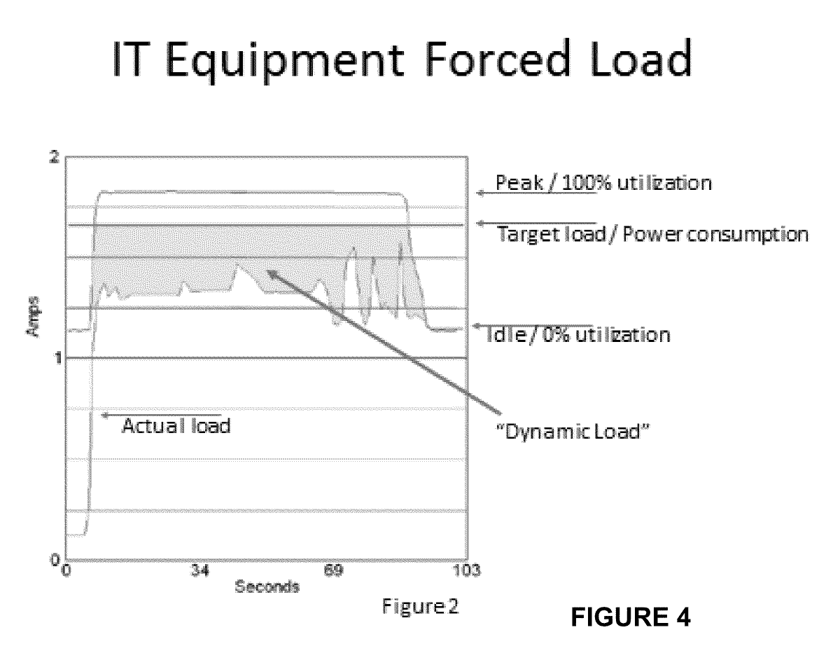

In the method, a grid frequency change is detected (132), by the data collection unit 30 for example, based on grid frequency drop/increase detection, utility supply signals, utility change requests, demand response requests etc. The data center can also detect outages and exception cases where a data center is required to run off of a generator. When the grid frequency change is detected or the utility company sends an adjustment request to the system 12, the system uses the data center to adjust the grid frequency (134). In the data center, servers, for example, have a high variability of power consumption, documented in a PAR4 energy efficiency certificate, with idle power consumption typically below 50% of the peak power consumption under 100% utilization as shown in FIG. 3 for example with typical load curves. In more detail, as most data centers are provisioned for peak demand even though such peak demand only happens occasionally and average utilization is well below 25%, there is a lot of spare capacity and potential power consumption available from data centers. By putting load on servers and IT equipment (136), power consumption can be dynamically increased and if monitored and adjusted on real-time, such power consumption can be set by forcing specific load onto such servers and IT equipment (“forced load”) as shown in FIG. 4 for example.

In alternative embodiments and implementations, the system provides a method that can sense frequency variation at the main power in-feed and correlation to the IT/cooling load to counter the variation. The system may also provide a method to respond to energy supply signals requesting +/−power consumption adjustments by adjusting the IT/cooling load. The system may also provide a method to predict and announce participation capacity to energy markets per real-time IT activity within the data center and a method to analyze and rate data center capability to participate in ancillary services market using PAR4 equipment reference data (with PAR4 being described in U.S. Pat. No. 7,970,561 which is incorporated herein by reference). The system also provide a method to shed load per application tiers and time constraints within a data center for ancillary services market participation and/or a method to add load per application tiers and time constraints within a data center for ancillary services market participation and/or a method to distribute load per application tiers and time constraints across data centers for ancillary services market participation.

The power consumption of equipment in the data center may be adjusted in various other ways. For example, the data center may have a power cap for a server in which, by reducing the clock speed of the server, the maximum power consumption of the server will be limited effectively adjusting power consumption down for the particular server. As another example, the system can shift application demand to another data center by adjusting the load balanced or virtualized applications and shifting them or some of the user to another location that adjusts power consumption of that data center down as well. Furthermore, the system may add specific software that uses CPU cycles to increase power consumption by waking up software that uses CPU cycles in pre-determined levels allows to set power consumption higher than the actual application demand requires. This can be done to flatten out power consumption of IT equipment or increase power consumption in cases the energy market pays for using more power.

While the foregoing has been with reference to a particular embodiment of the invention, it will be appreciated by those skilled in the art that changes in this embodiment may be made without departing from the principles and spirit of the disclosure, the scope of which is defined by the appended claims.

1. A method to adjust power grid frequency, comprising:
determining a grid frequency of a power grid connected to a data center having a plurality of pieces of equipment; and
forcing a load on the data center to adjust the grid frequency of the power grid connected to the data center.

2. The method of claim 1, wherein forcing the load on the data center further comprises forcing a load on one or more of the plurality of pieces of equipment in the data center.

3. The method of claim 2, wherein forcing the load further comprises adjusting a utilization of one or more of the plurality of pieces of equipment in the data center.

4. The method of claim 2, wherein forcing the load further comprises adjusting power consumption of one or more of the plurality of pieces of equipment in the data center.

5. The method of claim 4, wherein adjusting the power consumption further comprises increasing the power consumption of one or more of the plurality of pieces of equipment in the data center.

6. The method of claim 1, wherein determining the grid frequency further comprises receiving the grid frequency from a utility company.

7. The method of claim 1, wherein determining the grid frequency further comprises detecting the grid frequency by the data center.

8. The method of claim 1, wherein an IT forecast is used as a baseline complemented by a forced load to set the equipment to a certain power consumption level.

9. An apparatus that adjusts power grid frequency, comprising:
a set of infrastructure that controls an environment of the data center;
a data center building automation system that controls the set of infrastructure; and
an optimization engine that determines a grid frequency of a power grid connected to a data center having a plurality of pieces of equipment and forces a load on the data center to adjust the grid frequency of the power grid connected to the data center.

10. The apparatus of claim 9, wherein the optimization engine forces a load on one or more of the plurality of pieces of equipment in the data center.

11. The apparatus of claim 10, wherein the optimization engine adjusts a utilization of one or more of the plurality of pieces of equipment in the data center.

12. The apparatus of claim 10, wherein the optimization engine adjusts power consumption of one or more of the plurality of pieces of equipment in the data center.

13. The apparatus of claim 12, wherein the optimization engine increases the power consumption of one or more of the plurality of pieces of equipment in the data center.

14. The apparatus of claim 9, wherein the optimization engine receives the grid frequency from a utility company.

15. The apparatus of claim 9, wherein the optimization engine detects the grid frequency.

16. The apparatus of claim 9, wherein the optimization engine uses an IT forecast as a baseline complemented by a forced load to set the equipment to a certain power consumption level.

17. A method to predict and announce capacity of a data center, the method comprising:
determining, by an optimization engine, a load capacity of a set of infrastructure that controls an environment of the data center;
announce the load capacity of the data center to an energy market; and
adjusting a load of the set of infrastructure that controls an environment of the data center based on a demand from the energy market.

18. The method of claim 17, wherein determining the load capacity further comprises determining a PAR4 rating for each piece of infrastructure.

19. The method of claim 17, wherein adjusting the load further comprises one of shifting a load from the data center to another data center, power capping the set of infrastructure and dynamically reducing a capacity of the set of infrastructure.

20. The method of claim 17, wherein adjusting the load further comprises installing software and automatically adjusting the load of a CPU running the software.
